(19) United States
(12) Patent Application Publication
(10) Pub. No.: US 2003/0146651 A1
(43) Pub. Date: Aug. 7, 2003

(54) Seat assembly for a bicycle

(76) Inventor: Chin-Chang Wu, Taiping City (TW)

Correspondence Address: Cooper & Dunham LLP, 1185 Avenue of the Americas, New York, NY, 10036, US

(21) Appl. No.: 10/066,910

(22) Filed: Feb. 4, 2002

(51) Int. Cl. B62J 1/26

(52) U.S. Cl. 297/199

(57) ABSTRACT

A seat assembly for a bicycle has a base and an enveloped coat. The base is attached to a seat post of the bicycle and has a flange extending downward around the periphery of the base. The enveloped coat is attached to the top of the base and has a skirt surrounding the flange on the base. With such a seat assembly, the enveloped coat can provide a good and adjustable comfort effect to the bicycle rider.

### BACKGROUND OF THE INVENTION

1. Field of the Invention

The present invention relates to a seat assembly, and more particularly to a seat assembly for a bicycle and with an enveloped coat.

2. Description of Related Art

With reference to FIG. 5, a conventional seat assembly (60) for a bicycle in accordance with the prior art comprises a base (40), a foam layer (62) and a coat (61). A V-shaped strut (50) is attached to the bottom of the base (40) to connect with a seat post of the bicycle, such that the seat assembly (60) is attached to the seat post with the strut (50). A block (41) with a hole (411) is mounted on the bottom of the base (40) for each respective free end of the strut (50) extending into the hole (411) in the block (41). A lateral rod (51) is mounted on the strut (50) to enhance the structural strength of the strut (50). The foam layer (62) is made of a foam rubber material and is mounted on the top of the base (40). The coat (61) is made of a plastic material or a rubber material. The coat (61) covers the foaming layer (62) to secure the foam layer (62) on the base (40). Consequently, a bicycle rider can sit on the seat assembly to ride the bicycle. The coat (61) and the foam layer (62) can provide a comfort effect to the rider.

However, the foam layer (62) of the conventional seat assembly is just a single layer, and the single layer of conventional foam layer (62) cannot provide a good comfort effect to the rider. The comfort effect provided by the foam layer (62) is depended on the thickness of the foam layer (62). The thickness of the foam layer (62) on the conventional seat assembly is not adjustable, and thus the use of the conventional seat assembly is not versatile.

To overcome the shortcomings, the present invention tends to provide a seat assembly to mitigate or obviate the aforementioned problems.

### SUMMARY OF THE INVENTION

The main objective of the invention is to provide a seat assembly for a bicycle that has an enveloped coat to provide a good comfort effect to the bicycle rider. The seat assembly has a base and an enveloped coat. The base is attached to a seat post of the bicycle and has a flange extending downward around the periphery of the base. The enveloped coat is attached to the top of the base and has a skirt surrounding the flange on the base. With such a seat assembly, the enveloped coat can provide a good and adjustable comfort effect to the bicycle rider.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a seat assembly in accordance with the present invention;

FIG. 2 is an exploded perspective view of the seat assembly in FIG. 1;

FIG. 3 is a side plan view in partial cross section of the seat assembly in FIG. 1;

FIG. 4 is a side plan view in partial cross section of another embodiment of a seat assembly in accordance with the present invention; and

FIG. 5 is a bottom perspective view of a conventional seat assembly in accordance with the prior art.

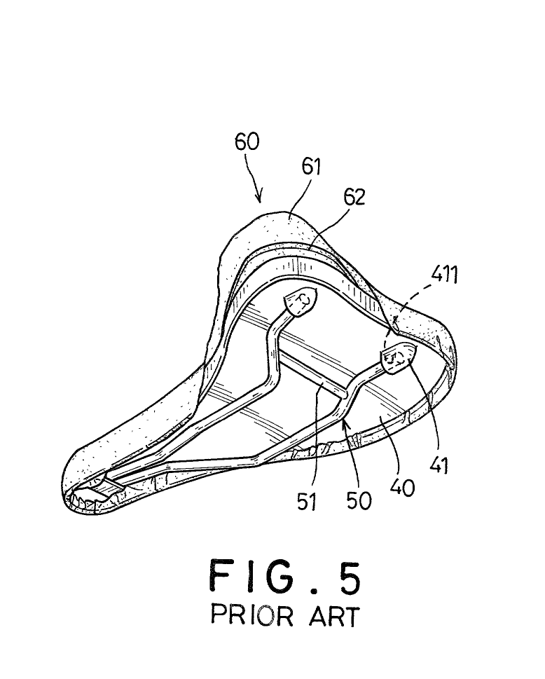

### DETAILED DESCRIPTION OF PREFERRED EMBODIMENT

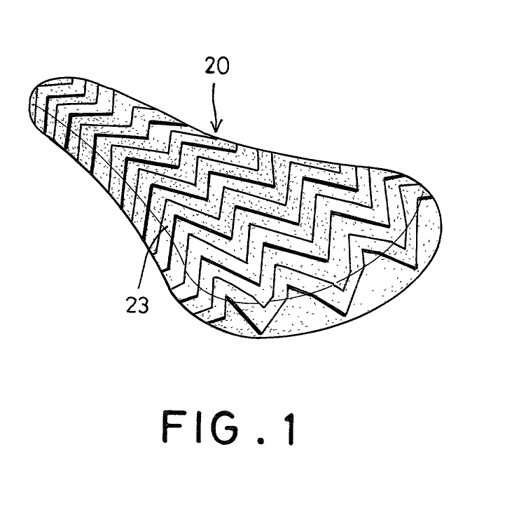

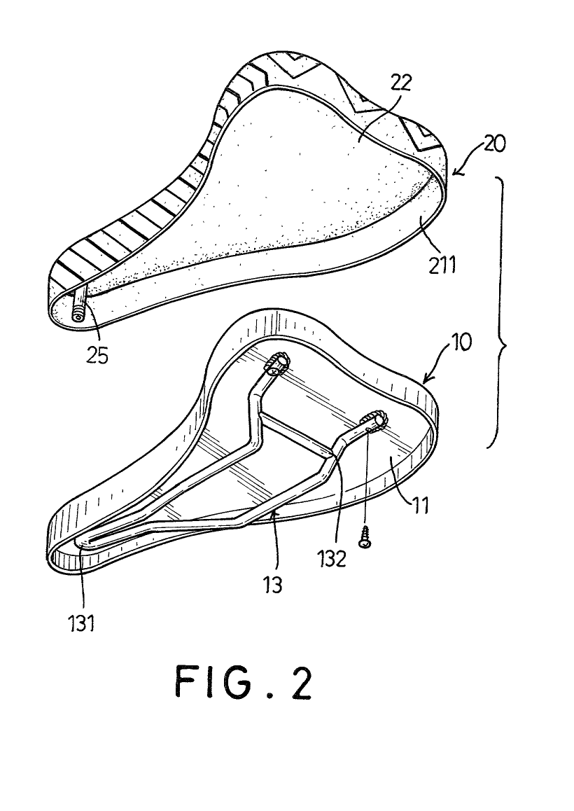

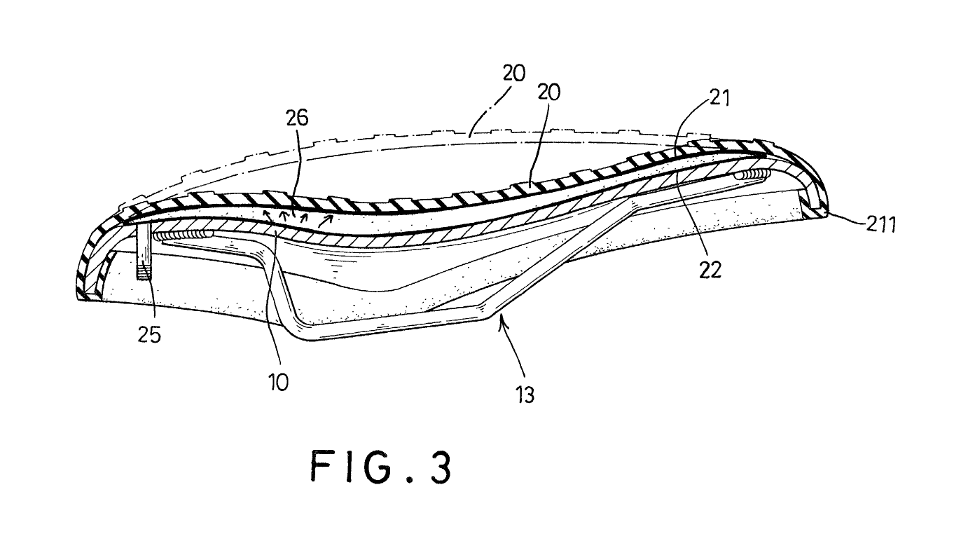

With reference to FIGS. 1 to 3, the seat assembly for a bicycle in accordance with the present invention comprises a base (10) and an enveloped coat (20). The base (10) is made of a metal material. The base (10) is attached to a seat post of the bicycle. A flange (not numbered) extends downward around the periphery of the base (10). A V-shaped strut (13) securely is attached to the bottom (11) of the base (10) and is adapted for connecting with the seat post of the bicycle. Consequently, the base (10) is attached to the seat post with the strut (13). The strut (13) has a closed end (131) and two free ends (not numbered). The closed end (131) and the free ends are all welded to the bottom (11) of the base (10). In addition, a bolt (not numbered) extends through each respective free end of the strut (13) and is screwed with the bottom (11) of the base (10). This can further enhance the combination between the base (10) and the strut (13). A lateral rod (132) is mounted on the strut ( 13) and across a position near the free ends of the strut (13) to enhance the structural strength of the strut (13).

The enveloped coat (20) is attached to the top of the base (10). A skirt (211) extends downward from the periphery of the coat (20) to surround the flange on the base (10). The free end of the skirt (211) of the enveloped coat (20) can be secured to the flange of the base (10) with glue. The coat (20) comprises a top layer (21) and a bottom layer (22). The bottom layer (22) is attached to a lower edge of the top layer (21) with the periphery of the bottom layer (22), such that an air chamber (26) is defined between the top layer (21) and the bottom layer (22). An air valve (25) is attached to the enveloped coat (20) and communicates with the air chamber (26), so that the air can be pumped into the air chamber (26) through the air valve (25) to inflate the enveloped coat (20). In addition, multiple protrusions (23) are formed on the top of the top layer (21) to increase the surface friction between the rider and the enveloped coat (20).

With such an enveloped coat (20), because there is air pressure contained in the air chamber (26) in the enveloped coat (20), the enveloped coat (20) can provide a good cushioning effect to the bicycle rider by avoiding the rider directly contacting the hard base (10). The air contained in the air chamber (26) can also provide a shock absorbing effect to the rider. In addition, because the air pressure in the air chamber (26) is adjustable through the air valve (25), the comfort effect and the shock absorbing effect provided by the enveloped coat (20) are also adjustable. The use of the seat assembly is more versatile than the prior art.

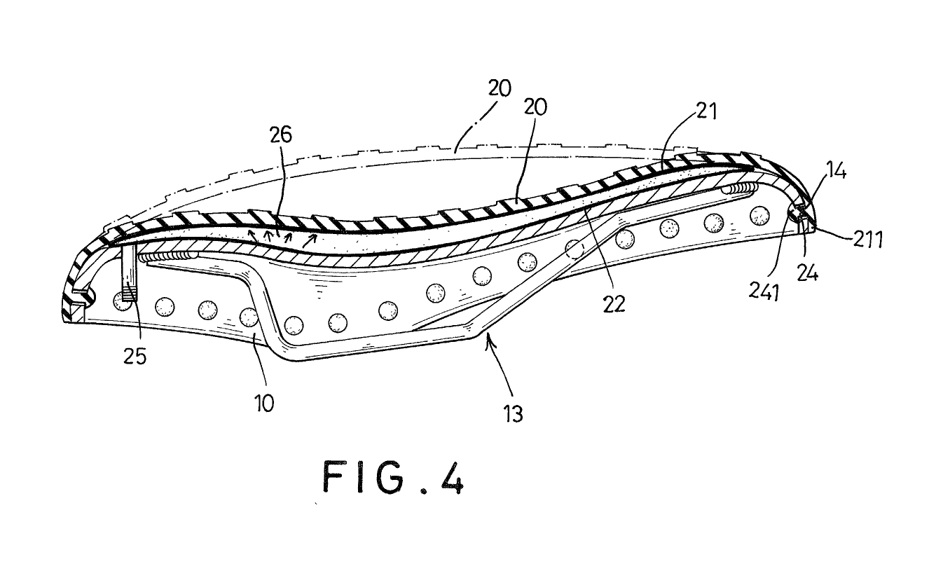

With reference to FIG. 4, multiple bores (14) are defined in the flange of the base (10). Multiple stubs (24) extend inward from the skirt (211) of the coat (20) and each extends through one of the bores (14) in the base (10). A head (241) with a large diameter is formed on each respective stub (24) and abuts an inner surface of the flange of the base (10). Consequently, the enveloped coat (20) can detachably attached to the base (10) by engagement between the stubs (24) and the bores (14) in the base (10). When the surface of the enveloped coat (20) is worn-out, the enveloped coat (20) can be replaced with a new one and thus the useful life of the seat assembly is prolonged.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A seat assembly for a bicycle with a seat post comprising:
a base adapted to be attached to a seat post of the bicycle and having a flange extending downward around a periphery of the base; and
an enveloped coat attached to a top of the base and having a skirt formed around a periphery of the enveloped coat for surrounding the flange on the base.

2. The seat assembly as claimed in claim 1, wherein the coat comprises a top layer and a bottom layer attached to the top layer with a periphery of the bottom layer so as to define an air chamber between the top layer and the bottom layer.

3. The seat assembly as claimed in claim 2 further comprising an air valve attached to the enveloped coat and communicating with the air chamber to inflate the enveloped coat.

4. The seat assembly as claimed in claim 2 further comprising multiple protrusions formed on a top surface of the top layer.

5. The seat assembly as claimed in claim 1, wherein multiple bores are defined in the flange of the base;
a stub extends inward from the skirt of the coat and extends through each respective bore in the base; and
a head is formed on each respective stub and abuts an inner surface of the flange.

6. The seat assembly as claimed in claim 1 further comprising a V-shaped strut securely attached to a bottom of the base and adapted for connecting with the seat post of the bicycle.

7. The seat assembly as claimed in claim 6, wherein the strut has a closed end welded to the bottom of the base and two free ends each welded to the bottom of the base.

8. The seat assembly as claimed in claim 7 further comprising a bolt extending through each respective free end of the strut and screwed with the bottom of the base.

9. The seat assembly as claimed in claim 7 further comprising a lateral rod mounted on the strut and across a position near the free ends of the strut of the base.
